(19) United States
(12) Patent Application Publication
(10) Pub. No.: US 2026/0116614 A1
(43) Pub. Date: Apr. 30, 2026

(54) TRAY WITH DIVIDER FEATURES

(71) Applicant: Graphic Packaging International, LLC, Atlanta, GA (US)

(72) Inventors: Liam Cooke, Leicestershire (GB); Marc Kavanagh, Kent (GB)

(21) Appl. No.: 19/368,988

(22) Filed: Oct. 24, 2025

Related U.S. Application Data
(60) Provisional application No. 63/711,863, filed on Oct. 25, 2024.
(60) Provisional application No. 63/730,104, filed on Dec. 10, 2024.

(51) Int. Cl. B65D 5/497; B31B 50/26; B31B 105/00; B31B 120/25; B31B 120/40; B65D 5/32; B65D 5/56

(52) U.S. Cl. CPC B65D 5/48044; B31B 50/262; B65D 5/321; B65D 5/56; B31B 2105/00; B31B 2120/25; B31B 2120/402

(57) ABSTRACT

A tray includes an upper construct that includes an upper flange panel. The upper flange panel includes a perimeter portion extending at least partially around first and second openings. The upper flange panel further includes a central portion disposed between the first and second openings. The upper construct also includes an upper side panel foldably connected to the central portion. The tray further includes a lower construct. The lower construct includes a bottom panel and a plurality of lower side panels foldably connected to the bottom panel and defining a receiving cavity. At least a portion of the upper construct is attached to the lower construct. The upper side panel extends through the receiving cavity and is attached to the bottom panel. The upper side panel at least partially defines first and second cavities.

### CROSS-REFERENCE TO RELATED APPLICATION

The present application claims priority to U.S. Provisional Patent Application No. 63/711,863 filed on Oct. 25, 2024 and to U.S. Provisional Patent Application No. 63/730,104 filed on Dec. 10, 2024.

### INCORPORATION BY REFERENCE

The disclosures of U.S. Provisional Patent Application No. 63/711,863 which was filed on Oct. 25, 2024 and U.S. Provisional Patent Application No. 63/730,104 which was filed on Dec. 10, 2024, are hereby incorporated by reference for all purposes as if presented herein in their entirety.

### TECHNICAL FIELD

This disclosure pertains to blanks for forming trays, trays, and methods for forming the trays from the blanks. More specifically, the present disclosure pertains to divider features such as divider panels extending from a bottom panel into a cavity of the tray.

### BACKGROUND OF THE DISCLOSURE

Trays are commonly used to hold products such as food products. Trays with divider features can keep certain products separate in various compartments.

### SUMMARY OF THE DISCLOSURE

In some embodiments, a tray for holding products may comprise an upper construct comprising an upper flange panel including a perimeter portion extending at least partially around first and second openings, the upper flange panel including a central portion disposed between the first and second openings. The upper construct may comprise an upper side panel foldably connected to the central portion. The tray may comprise a lower construct comprising a bottom panel. The lower construct may comprise a plurality of lower side panels foldably connected to the bottom panel and defining a receiving cavity. At least a portion of the upper construct may be attached to the lower construct and the upper side panel may extend through the receiving cavity and may be attached to the bottom panel, the upper side panel at least partially defining first and second cavities, wherein the first cavity may communicate with the first opening and the second cavity may communicate with the second opening. In some embodiments, the perimeter portion may comprise a first longitudinal panel opposite a second longitudinal panel, and first and second lateral panels, each extending between the first and second longitudinal panels.

In various embodiments, the upper side panel may extend from the first longitudinal panel to the second longitudinal panel. In some embodiments, the upper side panel may be a first upper side panel and the upper construct may further comprise a second upper side panel foldably connected to the central portion, and the second upper side panel may extend through the receiving cavity and may be attached to the bottom panel. In various embodiments, the first upper side panel may be foldably connected to a first lateral edge of the central panel and the second upper side panel may be foldably connected to a second lateral edge of the central panel. In some embodiments, the upper construct may further comprise an attachment panel foldably connected to the upper side panel and attached to the bottom panel. In various embodiments, the attachment panel may be attached in face-to-face contact to the bottom panel. In some embodiments, the plurality of lower side panels may include a first longitudinal lower side panel opposite a second longitudinal lower side panel.

In various embodiments, the lower construct may include a gap and the gap may include a first portion defined within the first longitudinal lower side panel, a second portion defined within the bottom panel, and a third portion defined within the second longitudinal lower side panel. In some embodiments, the central portion may be aligned with the gap. In various embodiments, the upper side panel may extend across at least a portion of the gap. In some embodiments, the upper side panel may be a first upper side panel, the upper construct may further comprise a second upper side panel foldably connected to the central portion, and the first upper side panel, the central portion, and the second upper side panel may at least partially define a wall cavity communicating with the gap. In various embodiments, the tray may further comprise a plastic liner at least partially attached to the upper construct and the lower construct, the plastic liner disposed within the first and second cavities.

In some embodiments, a set of blanks for forming a tray for holding products may comprise a first blank for forming an upper construct, the upper construct comprising an upper flange panel including a perimeter portion extending at least partially around first and second openings, the upper flange panel including a central portion disposed between the first and second openings. The upper construct may comprise an upper side panel foldably connected to the central portion. The set of blanks may comprise a second blank for forming a lower construct, the lower construct comprising a bottom panel. The lower construct may comprise a plurality of lower side panels foldably connected to the bottom panel and defining a receiving cavity. At least a portion of the upper construct may be attached to the lower construct and the upper side panel may extend through the receiving cavity and may be attached to the bottom panel, the upper side panel at least partially defining first and second cavities, wherein the first cavity may communicate with the first opening and the second cavity may communicate with the second opening when the tray is formed from the set of blanks.

In some embodiments, the perimeter portion may comprise a first longitudinal panel opposite a second longitudinal panel, and first and second lateral panels, each extending between the first and second longitudinal panels when the tray is formed from the set of blanks. In various embodiments, the upper side panel may extend from the first longitudinal panel to the second longitudinal panel. In some embodiments, the upper side panel may be a first upper side panel and the upper construct may further comprise a second upper side panel foldably connected to the central portion, and the second upper side panel may extend through the receiving cavity and may be attached to the bottom panel when the tray is formed from the set of blanks.

In some embodiments, a method of forming a tray for holding products from a set of blanks may comprise forming an upper construct from a first blank, the upper construct including a perimeter portion extending at least partially around first and second openings, the upper flange panel including a central portion disposed between the first and second openings, and an upper side panel foldably connected to the central portion. The method may comprise forming a lower construct from a second blank by folding a plurality of lower side panels upward from a bottom panel to define a receiving cavity. The method may comprise attaching at least a portion of the upper construct to the lower construct. The method may comprise extending the upper side panel through the receiving cavity and attaching the upper side panel to the bottom panel, wherein the upper side panel may at least partially define first and second cavities and wherein the first cavity may communicate with the first opening and the second cavity may communicate with the second opening. In some embodiments, the perimeter portion may include a first longitudinal panel opposite a second longitudinal panel, and first and second lateral panels, each extending between the first and second longitudinal panels. In various embodiments, the upper side panel may extend from the first longitudinal panel to the second longitudinal panel.

Those skilled in the art will appreciate the above stated advantages and other advantages and benefits of various additional embodiments reading the following detailed description of the embodiments with reference to the below-listed drawing figures.

According to common practice, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1A is a perspective view of a tray formed from a set of blanks according to a first embodiment of the disclosure.

FIG. 1B is an assembly view of the tray shown in FIG. 1A including a liner, an upper construct of the tray formed from a first blank, and a lower construct formed from a second blank.

FIG. 2A is a plan view of a blank for forming the upper construct of the tray according to the first embodiment of the disclosure.

FIG. 2B is a plan view of a blank for forming the lower construct of the tray according to the first embodiment of the disclosure.

FIG. 3 is a perspective view of a tray formed from a set of blanks according to a second embodiment of the disclosure.

FIG. 4A is a plan view of a blank for forming an upper construct of the tray according to the second embodiment of the disclosure.

FIG. 4B is a plan view of a blank for forming a lower construct of the tray according to the second embodiment of the disclosure.

FIG. 5A is a perspective view of a tray formed from a set of blanks according to a third embodiment of the disclosure.

FIG. 5B is a view of a portion of a bottom of the tray formed from a set of blanks according to the third embodiment of the disclosure.

FIG. 6A is a plan view of a blank for forming an upper construct of the tray according to the third embodiment of the disclosure.

FIG. 6B is a plan view of a blank for forming a lower construct of the tray according to the third embodiment of the disclosure.

FIG. 7A is a front view of a tray formed from a set of blanks according to a fourth embodiment of the disclosure.

FIG. 7B is a back view of the tray formed from a set of blanks according to the fourth embodiment of the disclosure.

FIG. 8A is a plan view of a blank for forming a lower construct of the tray according to the fourth embodiment of the disclosure.

FIG. 8B is a plan view of a blank for forming an upper construct of the tray according to the fourth embodiment of the disclosure.

FIG. 9 is a perspective view of a tray formed from a set of blanks according to a fifth embodiment of the disclosure.

FIG. 10A is a plan view of a first blank for forming an upper construct of the tray according to the fifth embodiment of the disclosure.

FIG. 10B is a plan view of a second blank for forming a lower construct of the tray according to the fifth embodiment of the disclosure.

FIG. 11 is a view of a tray formed from a set of blanks according to a sixth embodiment of the disclosure.

FIG. 12A is a plan view of a first blank for forming an upper construct of the tray according to the sixth embodiment of the disclosure.

FIG. 12B is a plan view of a second blank for forming a lower construct of the tray according to the sixth embodiment of the disclosure.

Corresponding parts are designated by corresponding reference numbers throughout the drawings.

### DETAILED DESCRIPTION

The present disclosure generally relates to various aspects of containers, constructs, trays, materials, packages, elements, and articles, and methods of making such containers, constructs, trays, materials, packages, elements, and articles. Although several different aspects, implementations, and embodiments are disclosed, numerous interrelationships between, combinations thereof, and modifications of the various aspects, implementations, and embodiments are contemplated hereby. In one illustrated embodiment, the present disclosure relates to forming a container or tray for holding food items or various other articles. However, in other embodiments, the container or tray can be used to form other non-food containing articles or may be used for heating or cooking.

Trays described herein can be used for holding one or more articles such as food products, e.g., portioned retail food products that can include one or more cookies, crackers, cakes, pastries, candies, nuts, popcorn, trail mix, gum, etc. In some embodiments, the articles can include frozen or non-frozen food products that can be provided in discrete portions, for example, chicken nuggets, French fries, onion rings, mozzarella sticks, chips, popcorn, other finger foods, etc. In embodiments, other types of articles that can include food products and/or non-food products can be placed in the tray for service to a customer. In some embodiments, such products can be contained in additional packaging and then placed in the tray. The tray could be otherwise shaped and arranged and could be used to hold other products and/or articles in similar or different environments without departing from the disclosure.

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The present disclosure generally relates to various aspects of trays, constructs, containers, materials, packages, elements, and articles, and methods of making such trays, constructs, containers, materials, packages, elements, and articles. Although several different aspects, implementations, and embodiments are disclosed, numerous interrelationships between, combinations thereof, and modifications of the various aspects, implementations, and embodiments are contemplated hereby. In one illustrated embodiment, the present disclosure relates to forming a tray for holding products. However, in other embodiments, the tray can be used to form other containers or may be used for organizing, separating, or displaying various items.

The tray may be configured to hold various products including food items, consumer goods, industrial components, or any other suitable products that may benefit from organized storage or display. The tray may be particularly suitable for applications where multiple products need to be separated into distinct compartments while maintaining structural integrity and ease of handling.

In this specification, the terms “inner,” “interior,” “outer,” “exterior,” “lower,” “bottom,” “upper,” and “top” indicate orientations determined in relation to fully erected and upright trays. As described herein, constructs can be formed with multiple walls, panels, portions, tabs, flaps, fold lines, and other aspects, which may be designated herein in terms relative to one another, e.g., “first,” “second,” “third,” etc., in sequential or nonsequential reference, without departing from the disclosure.

The tray may comprise an upper construct and a lower construct that may be assembled to form a multi-compartment storage system. The upper construct may include an upper flange panel that extends at least partially around first and second openings. The upper flange panel may include a central portion that may be disposed between the first and second openings. The upper construct may further include an upper side panel that may be foldably connected to the central portion of the upper flange panel. The lower construct may include a bottom panel and a plurality of lower side panels that fold upward in relation to the bottom panel to form a receiving cavity. At least a portion of the upper construct can be received in the receiving cavity including the upper side panel, which can be attached to the bottom panel to form a divider for the tray.

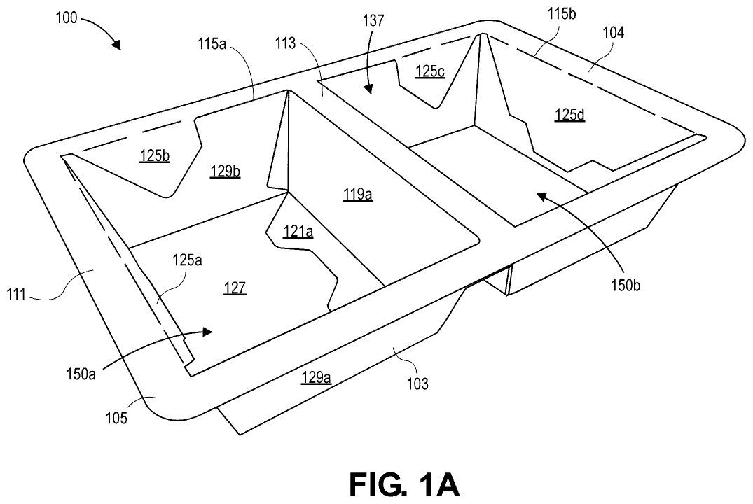

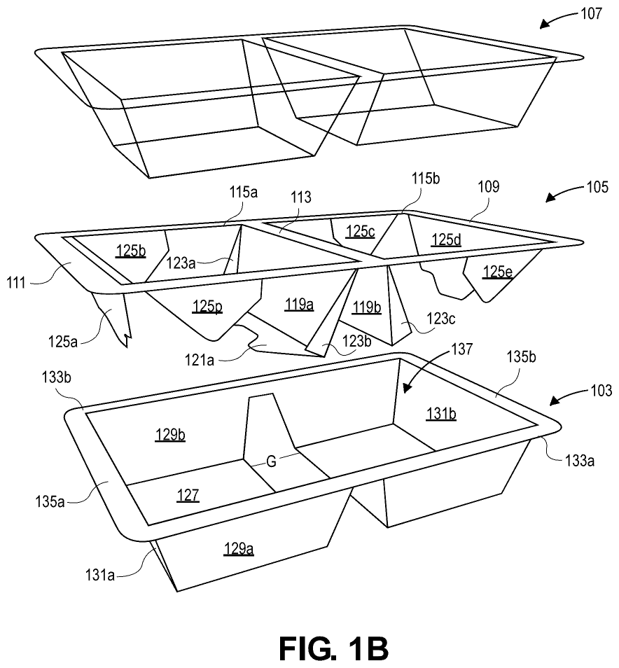

Referring to FIG. 1A, a tray 100 is shown in an assembled configuration and referring to FIG. 1B the tray is shown in an exploded configuration. FIGS. 1A and 1B will be described simultaneously. The tray 100 is formed from an upper construct 105 and a lower construct 103. The upper construct 105 contributes to the formation of a tray flange 104 that includes a perimeter portion 111 that may define the overall perimeter of the tray structure. The tray flange 104 further includes a central portion 113 disposed between a first opening 115a and a second opening 115b within the perimeter. The tray 100 may be divided into multiple compartments including a first compartment 150a that communicates with the first opening 115a and a second compartment 150b that communicates with the second opening 115b.

The lower construct 103 may comprise a bottom panel 127 and a plurality of lower side panels 129a, 129b and lateral lower side panels 131a, 131b that may be foldably connected to the bottom panel 127. The lower side panels 129a, 129b and lateral lower side panels 131a, 131b and may at least partially define a receiving cavity 137. The receiving cavity 137 may be configured to receive at least a portion of the upper construct 105 during assembly of the tray 100.

The tray 100 described herein thus provides a versatile arrangement for selective service of a variety of food products and/or different portions of such food products via the engagement of the upper construct 105 and lower construct 103 to form a divider wall in the interior of the tray 100. Divider features of the upper construct 105 and the lower construct 103 and the tray 100 formed therefrom can thus include features that form the divider wall in combinations and sub-combinations.

Referring to the exploded view of the tray 100 shown in FIG. 1B the relationship between the various components is shown. The tray 100 includes a liner 107, the upper construct 105 and the lower construct 103. The upper construct 105 may include multiple panels with various angled surfaces and vertical dividers, such as upper side panels 119a, 119b that form a divider wall in the tray 100. The upper construct 105 may include an upper flange panel 109 that includes a perimeter portion 111 that defines an opening within the perimeter, and a central portion 113 that divides the perimeter opening into first opening 115a and second opening 115b. The upper construct 105 may further include a set of upper sidewall panels 125a-125f foldably connected to the perimeter portion 111 of the upper flange panel 109 and two upper side panels 119a, 119b, each foldably connected to the central portion 113. The two upper side panels 119a, 119b each include respective base panels 121a, 121b, as well as two respective attachment panels 123a-123d (123a-123b connected to upper side panel 119a and 123c-123d connected to upper side panel 119b).

The lower construct 103 may include bottom panel 127 with longitudinal lower side panels 129a, 129b and lateral lower side panels 131a, 131b that fold upward relative to the bottom panel 127 to define receiving cavity 137. The lower construct 103 may further include lower flange panels 133a, 133b, 135a, 135b. The lower construct 103 may also include a gap G that extends through portions of the first longitudinal lower side panel 129a, the bottom panel 127, and the second longitudinal lower side panel 129b. The constructs 105, 103 may be aligned for assembly such that the upper construct 105 may fit into the lower construct 103, and the liner 107 may cover the interior of the assembled structure. The central portion 113 of the upper flange panel 109 may be aligned with the gap G when the tray 100 is assembled.

Each of the upper side panels 119a, 119b of the upper construct 105 may extend through the receiving cavity 137 and may be attached to the bottom panel 127 of the lower construct 103. The upper side panels 119a, 119b can be attached to the lower construct 103 such that the base panels 121a, 121b are in face-to-face contact with the bottom panel 127 and the attachment panels 123a, 123d are in face-to-face contact with longitudinal lower side panel 129b, and the attachment panels 123b, 123b are in face-to-face contact with longitudinal lower side panel 129a. The upper side panels 119a, 119b may at least partially define first and second cavities 150a, 150b within the assembled tray 100. The first cavity 150a may communicate with the first opening 115a in the upper flange panel 109, and the second cavity 150b may communicate with the second opening 115b in the upper flange panel 109. The first upper side panel 119a, the central portion 113, and the second upper side panel 119b may at least partially form a hollow wall defining a wall cavity that may communicate with the gap G in the lower construct 103. The wall cavity may be a nesting component of the tray 100, that is, it may allow the tray 100 to be placed within an identical second tray where the wall cavity receives central divider 113 and first and second upper side panels 119a, 119b of an adjacent stacked tray (e.g., nested trays) for compact storage and transport.

Liner 107 is disposed within the completed tray 100 by e.g., blow molding or other suitable process. In some embodiments, the liner 107 can be applied to one more of the blanks used to form the tray 100 before the constructs 103, 105 are formed and assembled. One, two, or all of the blanks and/or the tray 100 formed therefrom can, in some embodiments, be provided with the liner 107 that comprises a plastic layer such as polyethylene, a polyethylene terephthalate (PET) material, or any other thermoplastic material, or a bioplastic, such as vegetable oil or starch-based plastics. In one embodiment, such liner 107 can comprise polyethylene that can be softened and fused to one or more of the blanks and/or the tray formed therefrom. In an alternative embodiment, a liner that can be attached to the blank(s) and/or the tray formed therefrom can comprise PET or a similar material that is at least partially attached to the blank and/or tray by a heat seal layer (e.g., a thermoformable sealant grade transparent polyester packaging film, such as Mylar® XMPOL12 available from DuPont Teijin Films U.S. Limited Partnership of Hopewell, Virginia, or any suitable thermoformable sealant or adhesive, any suitable heat or pressure activated adhesive, or any other suitable material), wherein a PET liner can be more suitable for uses that require heating of the container in an oven.

Such a liner can be at least partially attached to the blank(s) and/or the tray formed therefrom for being positioned in contact with one or more food products held in the tray (e.g., during heating). In one embodiment, after heating and/or serving the food product, the blank or tray and an accompanying liner can be separated to allow both the blank and the liner to be disposed of (e.g., recycled, renewed, reused, etc.) separately. Optionally, the blank or tray can be provided separately from or without the liner 107.

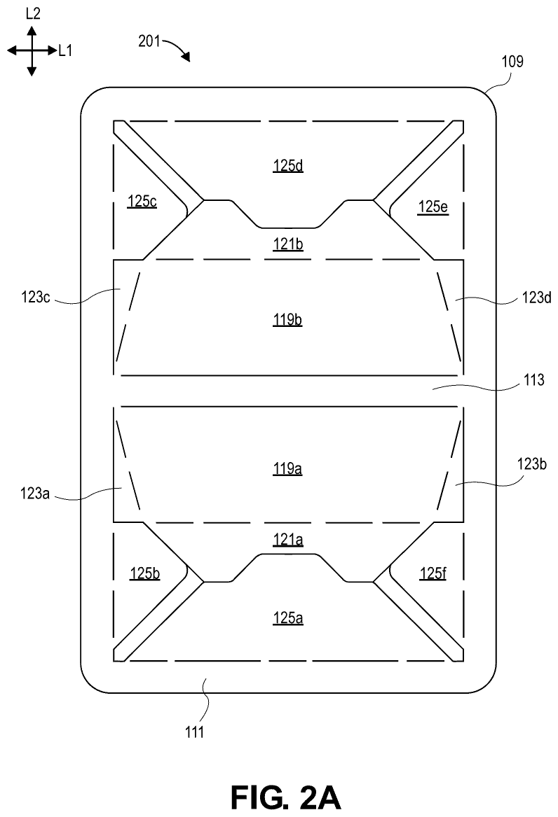

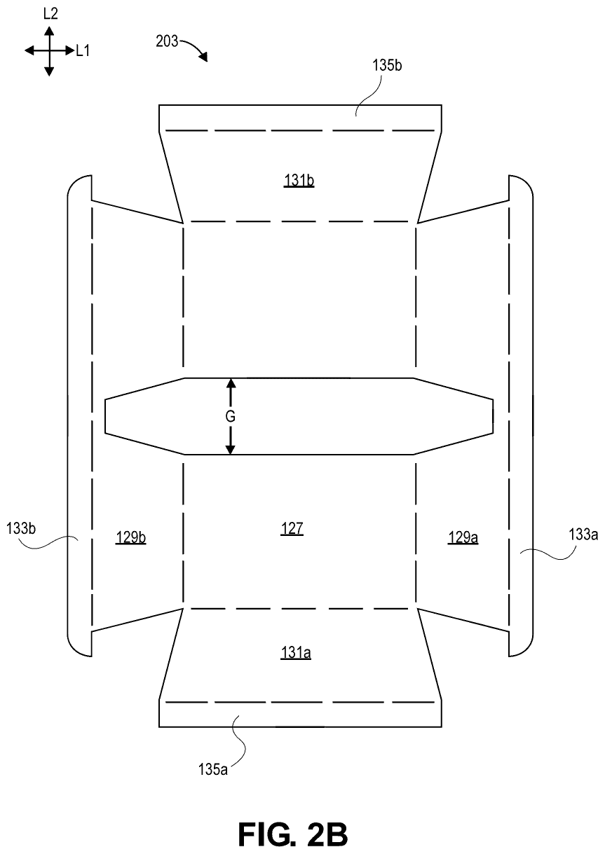

Referring to FIG. 2A, a blank 201 for forming the upper construct 105 is shown in an unfolded configuration. As shown, the blank 201 has a lateral axis L1 and a longitudinal axis L2. The blank 201 may include a rectangular structure with rounded corners forming the perimeter portion 111 of the upper flange panel 109. The blank 201 may include two regions separated by the central portion 113 of the upper flange panel 109. The blank 201 may further include upper sidewall panels 125a-125f foldably connected to the perimeter portion 111 of the upper flange panel 109. Base panel 121a and attachment panels 123a, 123b may be foldably connected to first upper side panel 119a. First upper side panel 119a may be foldably connected to a first edge of the central portion 113 and may extend between longitudinal upper sidewall panels 125b, 125f. Base panel 121b and attachment panels 123c, 123d may be foldably connected to second upper side panel 119b. The second upper side panel 119b may be foldably connected to an opposite or second edge of the central portion 113 and may extend between longitudinal sidewall panels 125c, 125e. Lateral upper sidewall panels 125a, 125d may extend between the longitudinal upper sidewall panels 125b, 125c, 125e, 125f.

Referring to FIG. 2B, a blank 203 for forming the lower construct 103 may be shown. As shown, the blank 203 has a lateral axis L1 and a longitudinal axis L2. The blank 203 may include the bottom panel 127 foldably connected to lower side panels 129a, 129b, 131a, 131b. The longer side panels may be referred to as longitudinal lower side panels 129a, 129b that each include a respective longitudinal lower flange panel 133a, 133b. Similarly, the shorter side panels may be referred to as lateral lower side panels 131a, 131b that each include a respective lateral lower flange panel 135a, 135b. The gap G may extend across portions of the bottom panel 127, the first longitudinal lower side panel 129a, and the second longitudinal lower side panel 129b. Alternatively, the gap G may extend across portions of the bottom panel 127 and lateral lower side panels 131a, 131b.

The blanks for forming the tray may be constructed from paperboard, cardboard, corrugated material, or other suitable sheet materials. The blanks may be die-cut to include the various panels, fold lines, and attachment features described herein. The fold lines may facilitate the transformation of the flat blanks into the three-dimensional tray structure.

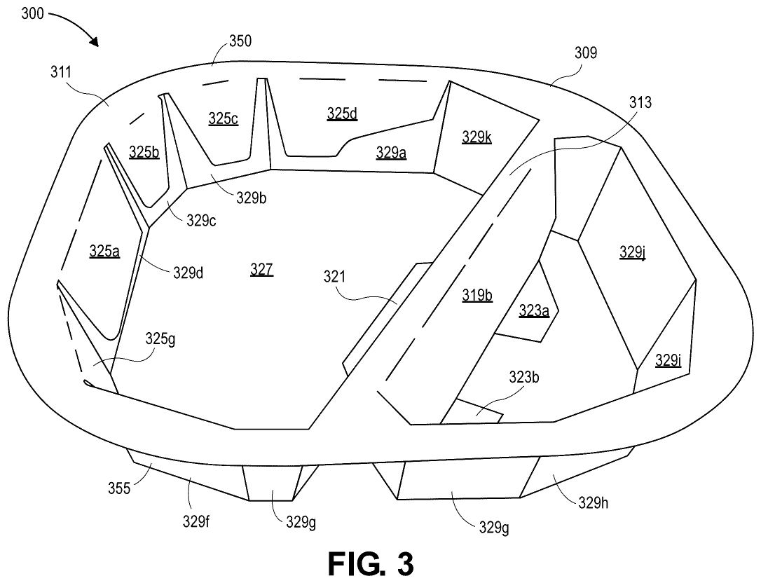

FIG. 3 is a perspective view of a tray 300 formed from a set of blanks according to a second embodiment of the disclosure. The tray 300 can include any of the components or features described for any other tray described in this application, including tray 100 associated with FIGS. 1A-2B. The second embodiment is generally similar to the prior embodiment, except for variations noted and variations that will be apparent to one of ordinary skill in the art. The set of blanks can be used to form an upper construct 350 and a lower construct 355 that can be attached to each other to assemble the tray 300. The liner (e.g., liner 107 in FIG. 1B) is not shown for clarity.

The tray 300 may be similar to tray 100, however tray 300 includes additional upper sidewall panels 325a-325g and lower side panels 329a-329k (for simplicity not all of the panels in FIG. 3 include element numbers) to form a more circular tray. Additionally, central portion 313 of upper flange panel 309 and divider panels 319a, 319b are arranged to form diagonal divider features in the tray 300, providing to two divided compartments of unequal sizes.

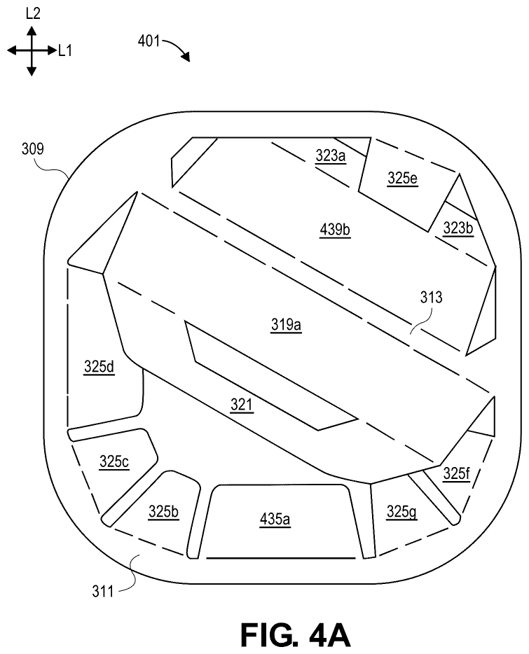

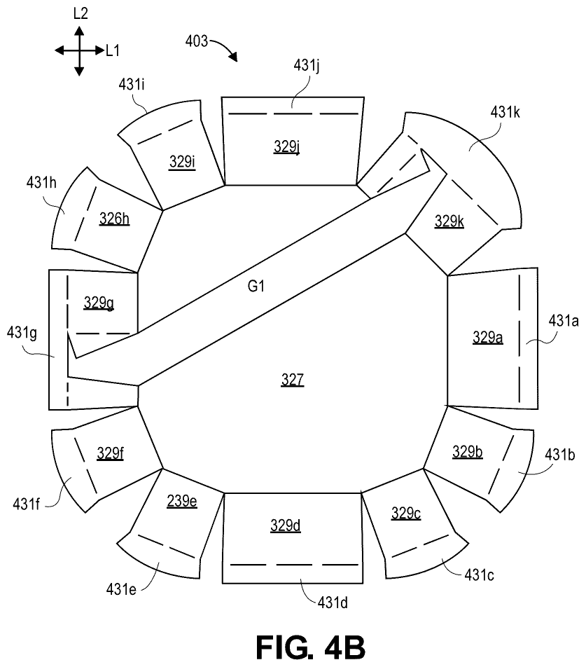

FIG. 4A is a plan view of a blank 401 for forming the upper construct 350 of the tray 300 according to the second embodiment of the disclosure. The blank 401 can include any of the components or features described for any other blank described in this application, including blank 201 associated with FIG. 2A.

The blank 401 includes upper flange panel 309 having a perimeter portion 311 and a central portion 313. The blank 401 further includes a plurality of upper sidewall panels 325a-325g foldably connected to the perimeter portion 311 and upper side panels 319a, 319b foldably connected to the central portion 313. First upper side panel 319a is foldably connected to base panel 321 and second upper side panels 319b is foldably connected to two smaller base panels 323a, 323b.

FIG. 4B is a plan view of a blank 403 for forming the lower construct 355 of the tray 300 according to the second embodiment of the disclosure. The blank 403 can include any of the components or features described for any other blank described in this application, including blank 203 associated with FIG. 2B.

The blank 403 can include a bottom panel 327 and a plurality of lower side panels 329a-329k foldably connected to the bottom panel 327. Each of the lower side panels 329a-329k is foldably connected to a respective lower flange panel 431a-431k. A gap G1 extends across portions of lower side panel 329g, the bottom panel 327, and lower side panel 329k.

When the tray 300 is formed from the set of blanks 401, 403, the base panels 323a, 323b and 321 of the upper construct 350 can be in face-to-face contact with the bottom panel 327 and optionally adhered together. Additionally, the central portion 313 and the upper side panels 319a, 319b of the upper construct 350 may be aligned with the gap G1 of the lower construct 350 when the tray 300 is assembled.

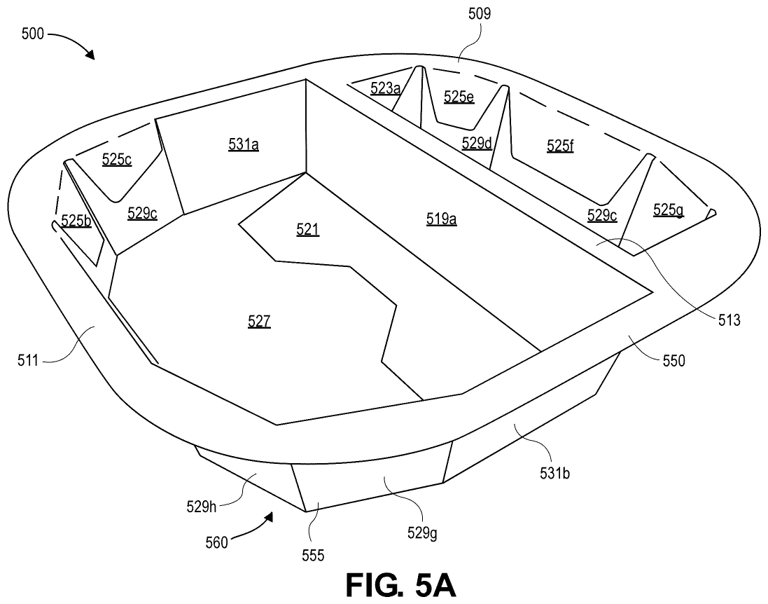

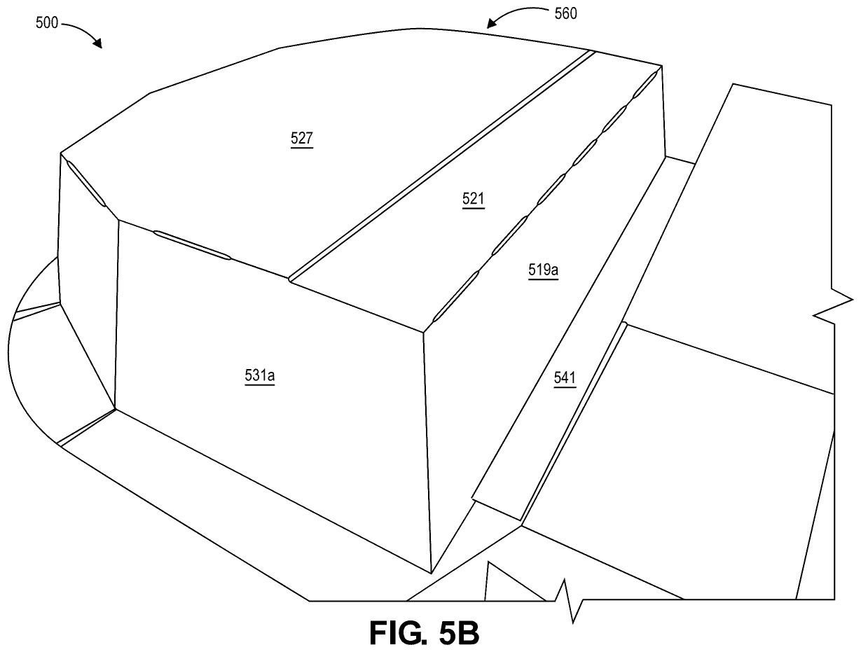

FIG. 5A is a view of a tray 500 formed from a set of blanks according to a third embodiment of the disclosure. The tray 500 can include any of the components or features described for any other tray described in this application. The third embodiment is generally similar to the prior embodiments, except for variations noted and variations that will be apparent to one of ordinary skill in the art. The liner (e.g., liner 107 in FIG. 1B) is not shown for clarity.

The tray 500 may be similar to tray 300 (see e.g., FIG. 3), however the tray 500 has additional or different features. For example, central portion 513 of upper flange panel 509 and divider panels 519a, 519b are arranged to form divider features that are orthogonal to perimeter portion 511 of upper flange panel 509 of the tray 500. Additionally, components of a first construct 550 cooperate with components of a second construct 555 to form a base 560 or bottom of the tray 500.

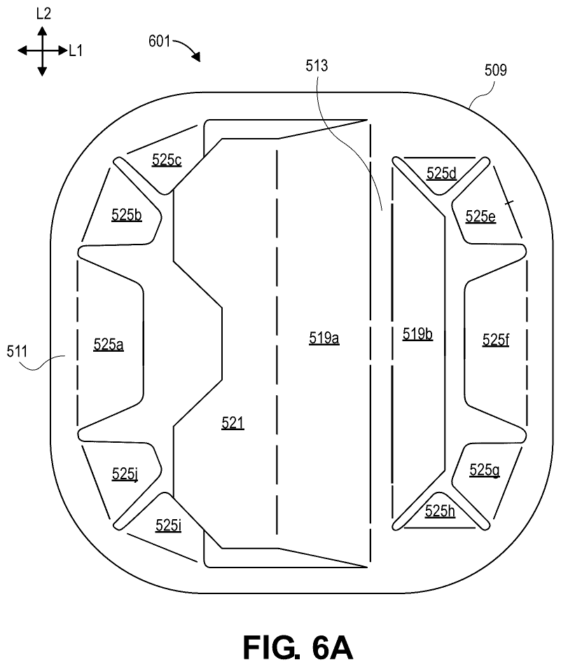

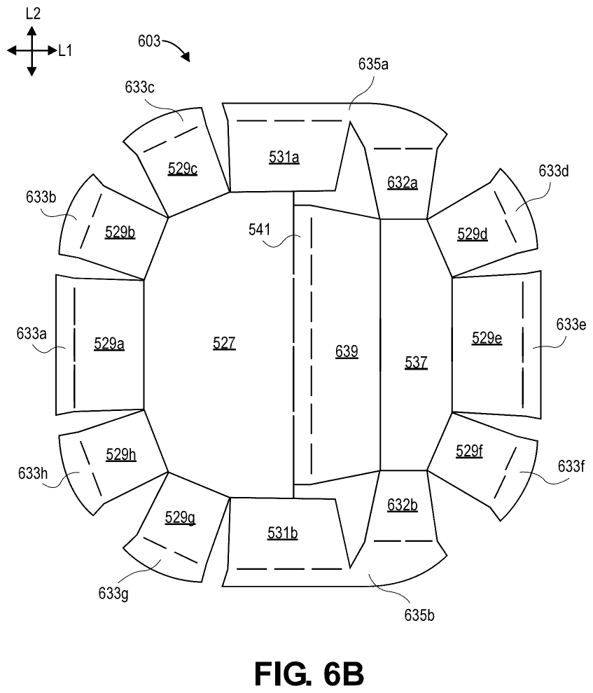

FIG. 5B is a view of a portion of a bottom 560 of the tray 500 formed from a set of blanks according to the third embodiment of the disclosure. Base panel 521, which is a component of blank 601 (FIG. 6A) of upper construct 550 cooperates with bottom panel 527, which is a component of blank 603 (FIG. 6B) of lower construct 555, to form at least a part of a base or bottom wall 560 of the tray 500.

FIG. 6A is a plan view of a blank 601 for forming the upper construct 550 of the tray 500 according to the second embodiment of the disclosure. The blank 601 can include any of the components or features described for any other blank described in this application, including blank 201 associated with FIG. 2A.

The blank 601 includes upper flange panel 509 having perimeter portion 511 and central portion 513. The blank 601 further includes a plurality of upper sidewall panels 525a-525j foldably connected to the perimeter portion 511 and upper side panels 519a, 519b foldably connected to the central portion 513. First upper side panel 519a is foldably connected to base panel 521.

FIG. 6B is a plan view of a blank 603 for forming the lower construct 555 of the tray 500 according to the second embodiment of the disclosure. The blank 603 can include any of the components or features described for any other blank described in this application, including blank 203 associated with FIG. 2B.

The blank 603 can include a first bottom panel 527 and a plurality of lower side panels 529a, 529b, 529c, 529g, 529h, 531a, 531b foldably connected to the first bottom panel 527. The blank 603 may also include a second bottom panel 537 and a plurality of lower side panels 529d, 529e, 529f, 632a, 632b foldably connected to the second bottom panel 537. Each of the lower side panels 529a-529h, 531a, 531b is foldably connected to a respective lower flange panel 633a-633h. Lower side panels 531a and 632a share a single flange panel 635a. Similarly, lower side panels 531b and 632b share a single flange panel 635b.

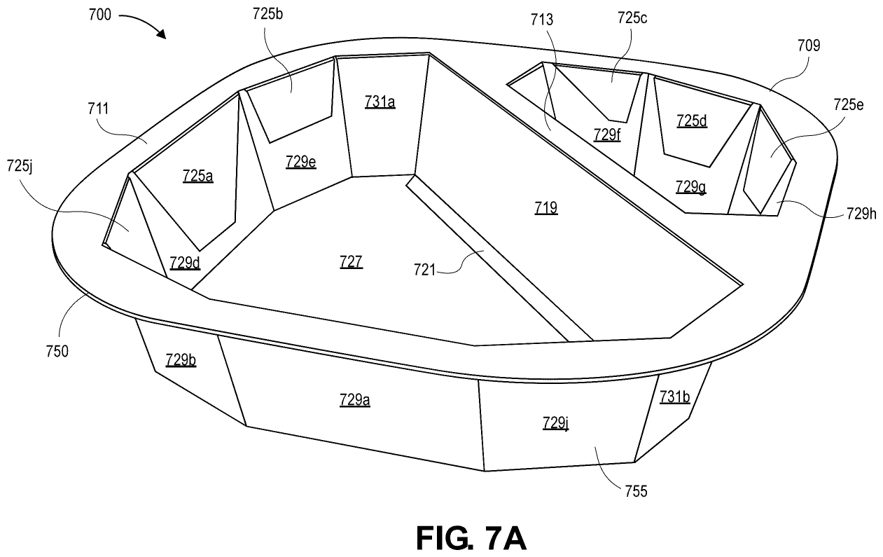

FIG. 7A is a front perspective view of a tray 700 and FIG. 7B is a rear perspective view of the tray according to a fourth embodiment of the disclosure. The tray 700 can include any of the components or features described for any other tray described in this application, including tray 100 associated with FIGS. 1A-2B. The fourth embodiment is generally similar to the prior embodiments, except for variations noted and variations that will be apparent to one of ordinary skill in the art. The liner (e.g., liner 107 in FIG. 1B) is not shown for clarity.

The tray 700 may be similar to tray 300, however the tray 700 has additional or different features. For example, components of a first blank and a second blank for forming the tray 700 combine to form a divider wall for the tray 700.

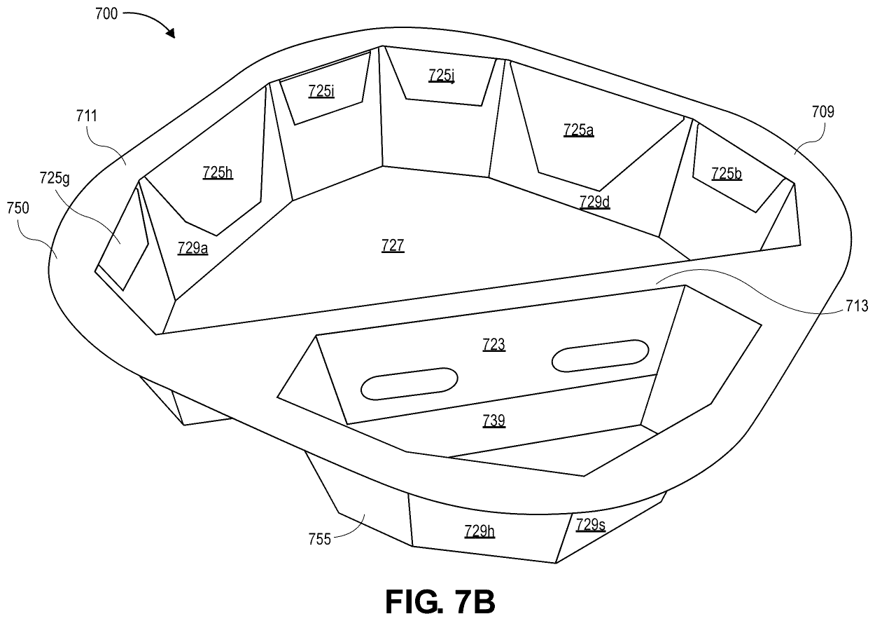

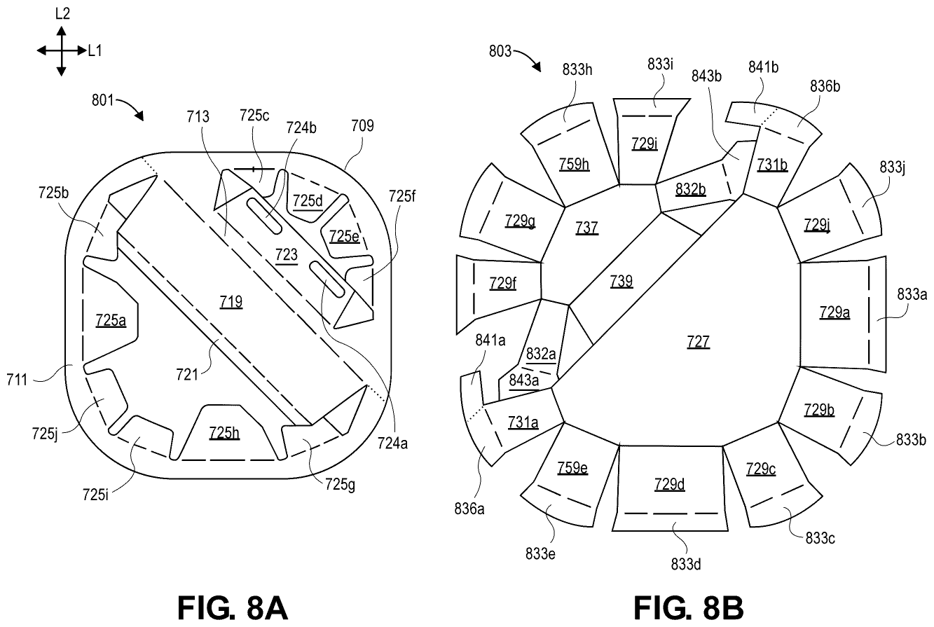

FIG. 8A is a plan view of the first blank 801 for forming an upper construct 750 of the tray 700 and FIG. 8B is a plan view of the second blank 803 for forming a lower construct 755 of the tray 700 according to the fourth embodiment of the disclosure. The blanks 801, 803 can include any of the components or features described for any other blank described in this application, including blank 201 associated with FIG. 2A or blank 203 associated with FIG. 2B.

The blank 801 includes upper flange panel 709 having perimeter portion 711 and central portion 713. The blank 801 further includes a plurality of upper sidewall panels 725a-725j foldably connected to the perimeter portion 711 and upper side panels 719, 723 foldably connected to the central portion 713. First upper side panel 719 is foldably connected to base panel 721. The upper side panel 723 includes two openings 724a, 724b. The two openings 724a, 724b allow a plastic liner (e.g., liner 107 shown in FIG. 1B) to adhere to the lower construct 750 through upper side panel 723, thus providing additional adhesion between the upper and lower constructs 150, 155, respectively of tray 700.

The blank 803 can include a plurality of lower side panels 729a-729e, 729j, 731a, 731b foldably connected to the first bottom panel 727. The blank 803 may also include a second bottom panel 737 and a plurality of lower side panels 729f-729i, 832a, 832b foldably connected to the second bottom panel 737. Lower side panels 832a, 832b are foldably connected to respective connecting panels 843a, 843b. The connecting panels 843a, 843b are also foldably attached to lower side panels 731a, 731b, respectively. Each of the lower side panels 729a-729j (except for lower side panels 843a, 843b) is foldably connected to a respective lower flange panel 833a-833j. Lower side panels 731a, 731b are attached to respective lower flange panels 836a, 836b. The lower flange panels 836a, 836b each are foldably connected to respective extension panels 841a, 841b. The blank 803 further includes lower divider panel 739 which can cooperate with upper side panel 723 of the blank 801 to form at least one divider feature of the tray 700.

FIG. 9 is a view of a tray 900 formed from a set of blanks according to a fifth embodiment of the disclosure. The tray 900 can include any of the components or features described for any other tray described in this application, including tray 100 associated with FIGS. 1A-2B. The fifth embodiment is generally similar to the prior embodiments, except for variations noted and variations that will be apparent to one of ordinary skill in the art. The liner (e.g., liner 107 in FIG. 1B) is not shown for clarity.

The tray 900 may be similar to tray 100, however the tray 900 has additional or different features. For example, the tray 900 includes divider features for forming a large compartment in addition to two smaller compartments.

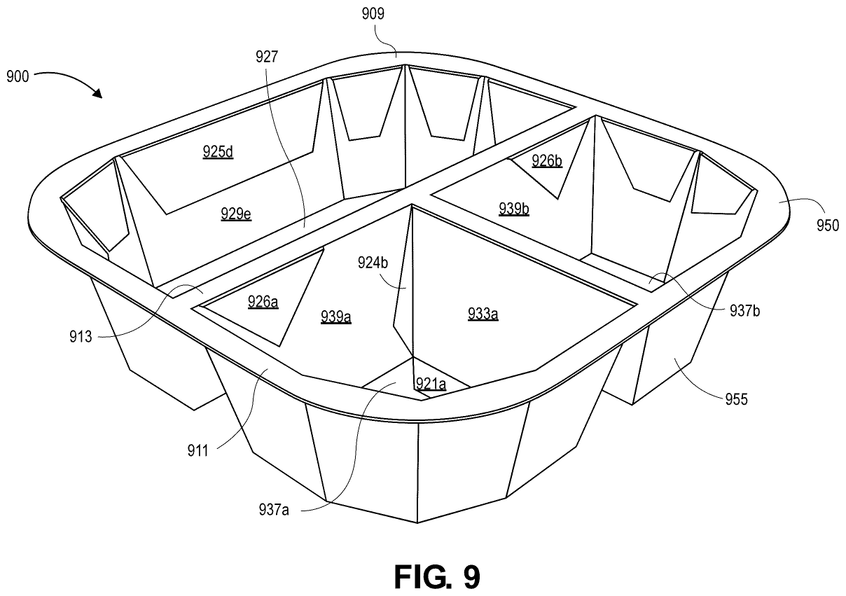

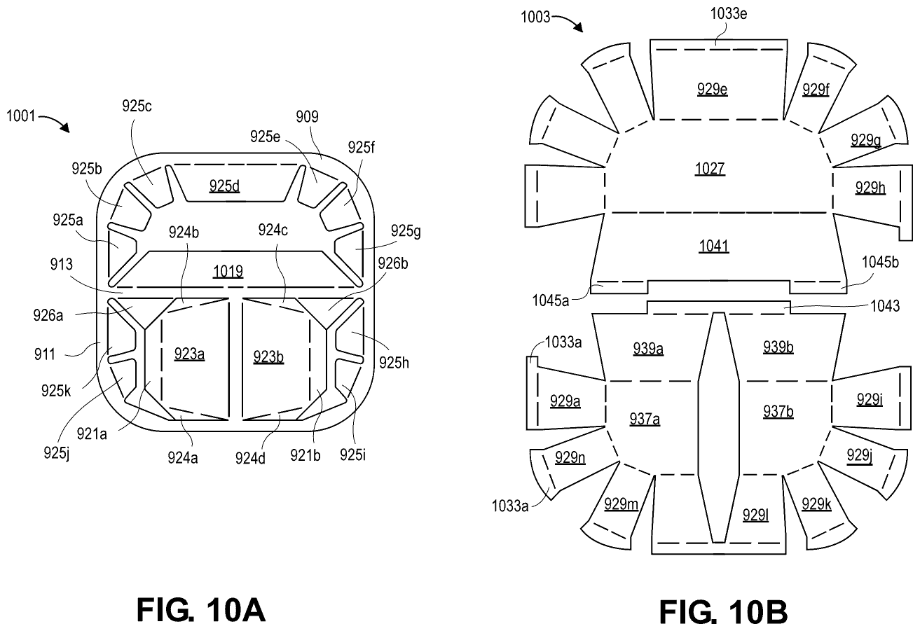

FIG. 10A is a plan view of a first blank 1001 for forming an upper construct 950 and FIG. 10B is a plan view of a second blank 1003 for forming a lower construct 955 of the tray 900 according to the fifth embodiment of the disclosure. The blanks 1001, 1003 can include any of the components or features described for any other blank described in this application, including blank 201 associated with FIG. 2A or blank 203 associated with FIG. 2B.

The blank 1001 includes upper flange panel 909 having perimeter portion 911 and central portion 913. The central portion 913 forms a T shape within a perimeter of the upper flange panel 909. The blank 1001 further includes a plurality of upper sidewall panels 925a-925k foldably connected to the perimeter portion 911 and upper side panels 1019, 923a, 923b foldably connected to the central portion 913. The upper side panels 923a, 923b are each foldably connected to respective base panels 921a, 921b and a respective pair of attachment panels 924a, 924b and 924c, 924d. Additionally, the blank 1001 includes upper sidewall panels 926a, 926b foldably connected to the central portion 913.

The blank 1003 can include a first bottom panel 1027 and a plurality of lower side panels 929b-929h foldably connected to the first bottom panel 1027. The blank 1003 may also include a second bottom panel 937a and a plurality of lower side panels 929a, 929n, 929m, 929l foldably connected to the second bottom panel 937a. Additionally, the blank 1003 may also include a third bottom panel 937b and a plurality of lower side panels 929i-929l foldably connected to the third bottom panel 937b. Lower side panel 929l is foldably attached to both the second and third bottom panels 937a, 937b. Each of the lower side panels 929a-929n is foldably connected to a respective lower flange panel 1033a-1033n.

A first lower divider panel 1041 is foldably connected to first bottom panel 1027. The first lower divider panel 1041 is foldably connected on a distal end to end flaps 1045a, 1045b. Similarly, second lower divider panel 939a is foldably connected to second bottom panel 937a and third lower divider panel 939b is foldably connected to third bottom panel 937b. Both the second lower divider panel 939a and the third lower divider panel 939b are foldably connected to end flap 1043. When the tray 900 is formed, the end flaps 1045a, 1045b, 1043 can combine to form a reinforcement panel for at least a portion of the central portion 913 of the upper flange panel 909. The upper side panels 1019, 923a, 923b and the lower divider panels 1041, 939a, 939b can cooperate to create divider features that can form three compartments in the tray 900.

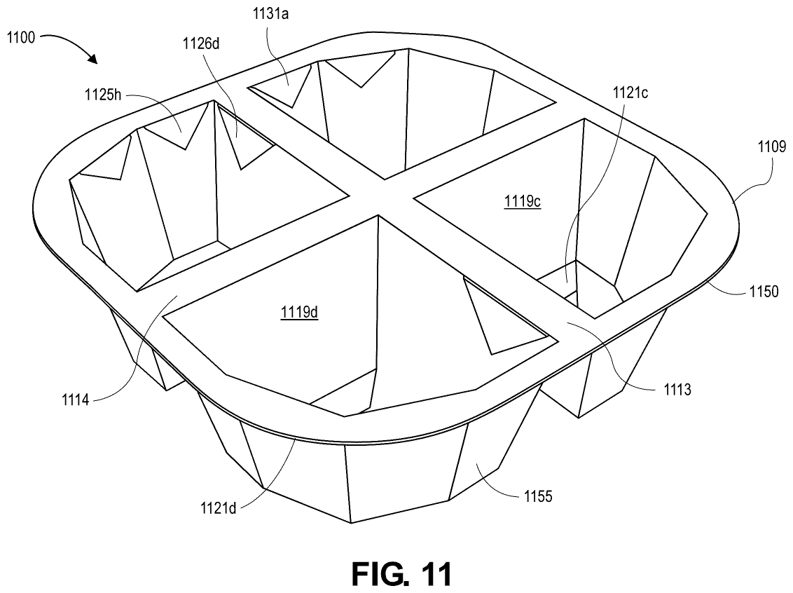

FIG. 11 is a view of a tray 1100 formed from a set of blanks according to a sixth embodiment of the disclosure. The tray 1100 can include any of the components or features described for any other tray described in this application, including tray 100 associated with FIGS. 1A-2B. The sixth embodiment is generally similar to the prior embodiments, except for variations noted and variations that will be apparent to one of ordinary skill in the art. The liner (e.g., liner 107 in FIG. 1B) is not shown for clarity.

The tray 1100 may be similar to tray 100, however the tray 1100 has additional or different features. For example, the tray 1100 includes divider features for forming four compartments.

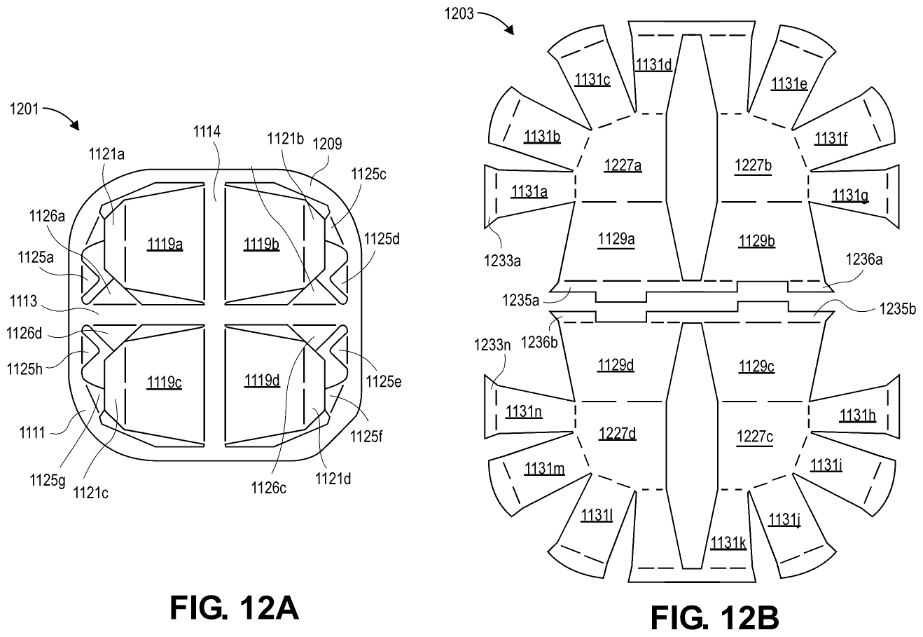

FIG. 12A is a plan view of a first blank 1201 for forming an upper construct 1150 and FIG. 12B is a plan view of a second blank 1203 for forming a lower construct 1155 of the tray 1100 according to the fifth embodiment of the disclosure. The blanks 1201, 1203 can include any of the components or features described for any other blank described in this application, including blank 201 associated with FIG. 2A or blank 203 associated with FIG. 2B.

The blank 1201 includes upper flange panel 1109 having perimeter portion 1111, a first central portion 1113, and a second central portion 1114. The first and second central portions 1113, 1114 cross one another to form a four-way intersection (e.g., a cross) within a perimeter of the upper flange panel 1109. The blank 1201 further includes a plurality of upper sidewall panels 1125a-1125h foldably connected to the perimeter portion 1111 and upper side panels 1119a-1119d foldably connected to the second central portion 1114. The upper side panels 1119a-1119d are each foldably connected to respective base panels 1121a-1121d. Additionally, the blank 1201 includes upper sidewall panels 1126a-1126d foldably connected to the first central portion 1113.

The blank 1203 can include a first bottom panel 1227a and a plurality of lower side panels 1131a-1131d foldably connected to the first bottom panel 1227a. The blank 1203 may also include a second bottom panel 1227b and a plurality of lower side panels 1131d-1131g foldably connected to the second bottom panel 1227b. Additionally, the blank 1203 may also include a third bottom panel 1227c and a plurality of lower side panels 1131h-1131k foldably connected to the third bottom panel 1227c. The blank 1203 also may also include a fourth bottom panel 1227d and a plurality of lower side panels 1131k-1131n foldably connected to the fourth bottom panel 1227d. Each of the lower side panels 1131a-1131n is foldably connected to a respective lower flange panel 1233a-1233n.

A first lower divider panel 1129a is foldably connected to first bottom panel 1227a. Similarly, second, third, and fourth divider panels 1129b-1129d are each foldably connected to a respective second, third and fourth bottom panel 1227b-1227d. The first lower divider panel 1227a and second lower divider panel 1227b are both foldably connected on a distal end to end flap 1235a. The second lower divider panel 1129b is also foldably connected to end flap 1236a. The third lower divider panel 1129c and fourth lower divider panel 1129d are both foldably connected on a distal end to end flap 1235b. The fourth lower divider panel 1129d is also foldably connected to end flap 1236b. When the tray 1100 is formed, the end flaps 1235a, 1235b, 1236a, 1236b can combine to form a reinforcement panel for at least a portion of the second central portion 1114 of the upper flange panel 1109. The upper side panels 1119a-1119d and the lower divider panels 1129a-1129d can cooperate to create divider features that can form four compartments in the tray 1100.

The assembly process for forming any of the trays described above may involve applying adhesive to specific attachment areas, inserting tabs into corresponding slots, or using other mechanical fastening methods to secure the various components together. The resulting tray may provide a stable platform for holding and organizing multiple products while maintaining easy access to each compartment.

The method of forming any tray described above may comprise forming the upper construct from a first blank and forming the lower construct from a second blank. The method may include folding the plurality of lower side panels upward from the bottom panel to define the receiving cavity. The method may further include attaching at least a portion of the upper construct to the lower construct and extending the upper side panel through the receiving cavity to attach the upper side panel to the bottom panel.

The components described herein could be omitted or could be otherwise shaped, arranged, positioned, or configured without departing from the disclosure. The tray can include any of the components or features described for any other tray described in this application. The present disclosure generally relates to various aspects of containers, constructs, trays, materials, packages, elements, and articles, and methods of making such containers, constructs, trays, materials, packages, elements, and articles. Although several different aspects, implementations, and embodiments are disclosed, numerous interrelationships between, combinations thereof, and modifications of the various aspects, implementations, and embodiments are contemplated hereby. In one illustrated embodiment, the present disclosure relates to forming a container or tray for holding food items or various other articles. However, in other embodiments, the container or tray can be used to form other non-food containing articles or may be used for heating or cooking.

Any of the features of the various embodiments of the disclosure can be combined with, replaced by, or otherwise configured with other features of other embodiments of the disclosure without departing from the scope of this disclosure.

In general, the blanks according to the present disclosure can be constructed from paperboard having a caliper so that it is heavier and more rigid than ordinary paper. The blanks can also be constructed of other materials, such as cardboard, or any other material having properties suitable for enabling the carton to function at least generally as described above. The blanks can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure. Furthermore, certain features and characteristics of each embodiment may be selectively interchanged and applied to other illustrated and non-illustrated embodiments of the disclosure.

What is claimed is:

1. A tray for holding products, the tray comprising:
an upper construct comprising:
an upper flange panel including a perimeter portion extending at least partially around first and second openings, the upper flange panel including a central portion disposed between the first and second openings; and
an upper side panel foldably connected to the central portion; and
a lower construct comprising:
a bottom panel; and
a plurality of lower side panels foldably connected to the bottom panel and defining a receiving cavity;
wherein at least a portion of the upper construct is attached to the lower construct and wherein the upper side panel extends through the receiving cavity and is attached to the bottom panel, the upper side panel at least partially defining first and second cavities, wherein the first cavity communicates with the first opening and the second cavity communicates with the second opening.

2. The tray of claim 1, wherein the perimeter portion comprises a first longitudinal panel opposite a second longitudinal panel, and first and second lateral panels, each extending between the first and second longitudinal panels.

3. The tray of claim 2, wherein the upper side panel extends from the first longitudinal panel to the second longitudinal panel.

4. The tray of claim 1, wherein the upper side panel is a first upper side panel and wherein the upper construct further comprises a second upper side panel foldably connected to the central portion, and wherein the second upper side panel extends through the receiving cavity and is attached to the bottom panel.

5. The tray of claim 4, wherein the first upper side panel is foldably connected to a first lateral edge of the central panel and wherein the second upper side panel is foldably connected to a second lateral edge of the central panel.

6. The tray of claim 1, wherein the upper construct further comprises an attachment panel foldably connected to the upper side panel and attached to the bottom panel.

7. The tray of claim 6, wherein the attachment panel is attached in face-to-face contact to the bottom panel.

8. The tray of claim 1, wherein the plurality of lower side panels include a first longitudinal lower side panel opposite a second longitudinal lower side panel.

9. The tray of claim 8, the lower construct including a gap and wherein the gap includes a first portion defined within the first longitudinal lower side panel, a second portion defined within the bottom panel, and a third portion defined within the second longitudinal lower side panel.

10. The tray of claim 9, wherein the central portion is aligned with the gap.

11. The tray of claim 9, wherein the upper side panel extends across at least a portion of the gap.

12. The tray of claim 9, wherein the upper side panel is a first upper side panel, the upper construct further comprising a second upper side panel foldably connected to the central portion, and wherein the first upper side panel, the central portion, and the second upper side panel at least partially define a wall cavity communicating with the gap.

13. The tray of claim 1, further comprising a plastic liner at least partially attached to the upper construct and the lower construct, the plastic liner disposed within the first and second cavities.

14. A set of blanks for forming a tray for holding products, the set of blanks comprising:
a first blank for forming an upper construct, the first blank comprising:
an upper flange panel including a perimeter portion extending at least partially around first and second openings, the upper flange panel including a central portion disposed between the first and second openings; and
an upper side panel foldably connected to the central portion; and
a second blank for forming a lower construct, the second blank comprising:
a bottom panel; and
a plurality of lower side panels foldably connected to the bottom panel and defining a receiving cavity in the tray formed from the set of blanks;
wherein the upper side panel extends through the receiving cavity and is attached to the bottom panel, the upper side panel at least partially defining first and second cavities, the first cavity communicates with the first opening and the second cavity communicates with the second opening when the tray is formed from the set of blanks.

15. The set of blanks of claim 14, wherein the perimeter portion comprises a first longitudinal panel opposite a second longitudinal panel, and first and second lateral panels, each extending between the first and second longitudinal panels when the tray is formed from the set of blanks.

16. The set of blanks of claim 15, wherein the upper side panel extends from the first longitudinal panel to the second longitudinal panel.

17. The set of blanks of claim 14, wherein the upper side panel is a first upper side panel and wherein the upper construct further comprises a second upper side panel foldably connected to the central portion, and wherein the second upper side panel extends through the receiving cavity and is attached to the bottom panel when the tray is formed from the set of blanks.

18. The set of blanks of claim 17, wherein the first upper side panel is foldably connected to a first lateral edge of the central panel and wherein the second upper side panel is foldably connected to a second lateral edge of the central panel.

19. The set of blanks of claim 14, wherein the first blank further comprises an attachment panel foldably connected to the upper side panel and for attachment to the bottom panel of the second blank when the tray is formed from the set of blanks.

20. The set of blanks of claim 14, wherein the plurality of lower side panels include a first longitudinal lower side panel opposite a second longitudinal lower side panel.

21. The set of blanks of claim 20, the second blank including a gap and wherein the gap includes a first portion defined within the first longitudinal lower side panel, a second portion defined within the bottom panel, and a third portion defined within the second longitudinal lower side panel.

22. The set of blanks of claim 21, wherein the upper side panel is a first upper side panel, the upper construct further comprising a second upper side panel foldably connected to the central portion, and wherein the first upper side panel, the central portion, and the second upper side panel at least partially define a wall cavity communicating with the gap when the tray is formed from the set of blanks.

23. A method of forming a tray from a set of blanks, the method comprising:
forming an upper construct from a first blank, the first blank including a perimeter portion extending at least partially around first and second openings, the upper flange panel including a central portion disposed between the first and second openings, and an upper side panel foldably connected to the central portion;
forming a lower construct from a second blank by folding a plurality of lower side panels upward from a bottom panel to define a receiving cavity;
attaching at least a portion of the upper construct to the lower construct; and
extending the upper side panel through the receiving cavity and attaching the upper side panel to the bottom panel, wherein the upper side panel at least partially defines first and second cavities and wherein the first cavity communicates with the first opening and the second cavity communicates with the second opening.

24. The method of claim 23, wherein the perimeter portion includes a first longitudinal panel opposite a second longitudinal panel, and first and second lateral panels, each extending between the first and second longitudinal panels.

25. The method of claim 24, wherein the upper side panel extends from the first longitudinal panel to the second longitudinal panel.

26. The method of claim 23, wherein the upper side panel is a first upper side panel and wherein the first blank further comprises a second upper side panel foldably connected to the central portion, and wherein the second upper side panel extends through the receiving cavity and is attached to the bottom panel.

27. The method of claim 26, wherein the first upper side panel is foldably connected to a first lateral edge of the central panel and wherein the second upper side panel is foldably connected to a second lateral edge of the central panel.

28. The method of claim 23, wherein the first blank further comprises an attachment panel foldably connected to the upper side panel, the method comprises attaching the attachment panel to the bottom panel

29. The method of claim 23, wherein the plurality of lower side panels include a first longitudinal lower side panel opposite a second longitudinal lower side panel.

30. The method of claim 29, the lower construct including a gap and wherein the gap includes a first portion defined within the first longitudinal lower side panel, a second portion defined within the bottom panel, and a third portion defined within the second longitudinal lower side panel.

31. The method of claim 30, wherein the central portion is aligned with the gap.

32. The method of claim 30, wherein the upper side panel is a first upper side panel, the upper construct further comprising a second upper side panel foldably connected to the central portion, and wherein the first upper side panel, the central portion, and the second upper side panel at least partially define a wall cavity communicating with the gap.

33. The method of claim 23, further comprising at least partially attaching a plastic liner to the upper construct and the lower construct, the plastic liner disposed within the first and second cavities.
